(19) United States
(12) Patent Application Publication
(10) Pub. No.: US 2026/0108012 A1
(43) Pub. Date: Apr. 23, 2026

(54) SEGMENTED ARTICLES OF FOOTWEAR

(71) Applicant: NIKE, Inc., Beaverton, OR (US)

(72) Inventors: Bryan N. Farris, North Plains, OR (US); Todd A. Waatti, Battle Ground, WA (US)

(73) Assignee: NIKE, Inc., Beaverton, OR (US)

(21) Appl. No.: 19/360,639

(22) Filed: Oct. 16, 2025

Related U.S. Application Data
(60) Provisional application No. 63/708,653, filed on Oct. 17, 2024.

(51) Int. Cl. A43B 3/24; A43B 1/14

(52) U.S. Cl. CPC A43B 3/248; A43B 1/14

(57) ABSTRACT

An article of footwear can include a three-dimensional printed body having a longitudinal axis extending from a forefoot region of the body to a heel region of the body. The body can include a plurality of discrete segments that are coupled together. A first segment of the plurality of segments defines the forefoot region and a second segment of the plurality of segments defines the heel region. Each segment of the plurality of segments includes an opening extending in a direction parallel to the longitudinal axis. The article of footwear can also include a connection member disposed within the openings of the segments from the first segment to the second segment. The connection member couples the plurality of segments together.

### CROSS REFERENCE TO RELATED APPLICATION

This application claims the benefit of U.S. Provisional Ser. No. 63/708,653 , filed Oct. 17, 2024, which is incorporated by reference herein.

### FIELD

The present disclosure is directed to articles of footwear, and more particularly to segmented articles of footwear.

### BACKGROUND

An article of footwear (also referred to herein as “article”) typically includes two main components: a sole structure and an upper. The sole structure is configured for supporting the wearer's foot and providing cushioning between the wearer's foot and the ground. The upper is coupled to the sole structure and is configured for securing the wearer's foot to the sole structure.

### BRIEF DESCRIPTION OF THE DRAWINGS

FIG. 1 depicts a lateral side view of an example of an article of footwear comprising a segmented body.

FIG. 2 depicts a perspective view of the article of footwear of FIG. 1, separated into segments.

FIG. 3 depicts a perspective view of a segment of the article of footwear of FIG. 1.

FIG. 4 depicts a partial perspective view of the article of footwear of FIG. 1, partially separated into segments.

FIG. 5 depicts a perspective view of the article of footwear of FIG. 1, with an optional cover.

FIG. 6 depicts a perspective view of an example of an article of footwear comprising a segmented body, separated into segments.

FIG. 7 depicts a lateral side view of the article of footwear of FIG. 6, partially separated into segments.

FIG. 8 depicts a partial perspective view of the article of footwear of FIG. 6, separated into segments.

FIG. 9 depicts a perspective view of a segment of the article of footwear of FIG. 6 together with an optional side member.

FIG. 10 depicts a partial perspective view of the article of footwear of FIG. 6, partially separated into segments and an optional cushioning element.

FIG. 11 depicts a partial perspective view of an example of an article of footwear comprising a segmented body.

FIG. 12A depicts a lateral side view of an example of an article of footwear comprising a segmented body.

FIG. 12B depicts a lateral side view of another example of an article of footwear comprising a segmented body.

FIG. 13 depicts a partial perspective view of an upper partially separated from the body of the article of footwear of FIG. 12A.

FIG. 14 depicts a perspective view of a lateral side of an example of a segmented body for an article of footwear, separated into segments.

FIG. 15 depicts a perspective view of a lateral side of an example of an article of footwear comprising a segmented body.

FIG. 16 is a flowchart illustrating an example process for printing a segmented body for an article of footwear, according to one example.

FIG. 17 depicts a perspective view of an example of a segmented body for an article of footwear and an example of a connection member.

FIGS. 18A-18C are schematic cross-sectional views depicting examples of connection members received in openings of body segments of articles of footwear.

### DETAILED DESCRIPTION

### General Considerations

The systems and methods described herein, and individual components thereof, should not be construed as being limited to the particular uses or systems described herein in any way. Instead, this disclosure is directed toward all novel and non-obvious features and aspects of the various disclosed examples, alone and in various combinations and subcombinations with one another. For example, any features or aspects of the disclosed examples can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application, the singular forms “a,” “an,” and “the” include the plural forms unless the context clearly dictates otherwise. Additionally, the term “includes” means “comprises. ” Further, the terms “coupled” or “secured” encompass mechanical and chemical couplings, as well as other practical ways of coupling or linking items together, and do not exclude the presence of intermediate elements between the coupled items unless otherwise indicated, such as by referring to elements, or surfaces thereof, being “directly” coupled or secured. Furthermore, as used herein, the term “and/or”means any one item or combination of items in the phrase.

As used herein, the term “exemplary” means serving as a non-limiting example, instance, or illustration. As used herein, the terms “e.g.,” and “for example,” introduce a list of one or more non-limiting examples, instances, and/or illustrations.

Although the operations of some of the disclosed methods are described in a particular, sequential order for convenient presentation, this manner of description encompasses rearrangement, unless a particular ordering is required by specific language set forth below. For example, operations described sequentially may in some cases be rearranged or performed concurrently. Moreover, for the sake of simplicity, the attached figures may not depict the various ways in which the disclosed things and methods can be used in conjunction with other things and methods. Additionally, the description sometimes uses terms like “provide” and “produce” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

As used herein, the directional terms (e.g., “upper” and “lower”) generally correspond to the orientation of an article of footwear or sole assembly as it is configured to be worn by a wearer. For example, an “upwardly-facing surface” and/or an “upper surface” of a sole assembly refers to the surface oriented in the “superior” anatomical direction (i.e., toward the head of a wearer) when the article of footwear is being worn by the wearer. Similarly, the directional terms “downwardly” and/or “lower” refer to the anatomical direction “inferior” (i.e., toward the ground and away from the head of the wearer). “Front” means “anterior” (e.g., towards the toes), and “rear” means “posterior” (e.g., towards the heel). “Medial” means “toward the midline of the body,” and “lateral” means “away from the midline of the body. ” “Longitudinal axis” refers to a centerline of the article from the heel to toe. Similarly, a “longitudinal length” refers to a length of the article along the longitudinal axis and a “longitudinal direction” refers to a direction along the longitudinal axis.

As used herein, the term “sole structure” refers to any combination of materials that provides support for a wearer's foot and bears the surface that is in direct contact with the ground or playing surface, such as, for example, a single sole; a combination of an outsole and an inner sole; a combination of an outsole, a midsole, and an inner sole; and a combination of an outer covering, an outsole, a midsole and an inner sole.

As used herein, the terms “attached” and “coupled” generally mean physically connected or linked, which includes items that are directly attached/coupled and items that are attached/coupled with intermediate elements between the attached/coupled items, unless specifically stated to the contrary.

As used herein, the terms “fixedly attached” and “fixedly coupled” refer to two components joined in a manner such that the components may not be readily separated from one another without destroying and/or damaging one or both components. Exemplary modalities of fixed attachment may include joining with permanent adhesive, stitches, welding or other thermal bonding, and/or other joining techniques. In addition, two components may be “fixedly attached” or “fixedly coupled” by virtue of being integrally formed, for example, in a molding process. In contrast, the terms “removably attached” or “removably coupled” refer to two components joined in a manner such that the components can be readily separated from one another to return to their separate, discrete forms without destroying and/or damaging either component. Exemplary modalities of temporary attachment may include mating-type connections, releasable fasteners, removable stitches, and/or other temporary joining techniques.

As used herein, the terms “articles of footwear,” “articles,” and/or “footwear” mean any type of footwear, including, for example, casual shoes, walking shoes, sneakers, tennis shoes, running shoes, soccer shoes, football shoes, rugby shoes, basketball shoes, baseball shoes, boots, sandals, etc.

Although the figures may illustrate an article of footwear intended for use on only one foot (e.g., a right foot) of a wearer, one skilled in the art and having the benefit of this disclosure will recognize that a corresponding article of footwear for the other foot (e.g., a left foot) would be a mirror image of the right article of footwear.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, abstract, and drawings.

### Examples of the Disclosed Technology

Aspects and advantages of the disclosed technology will be set forth in part in the following description, or may be obvious from the description, or may be learned through practice of the technology disclosed in the description.

Disclosed herein are articles of footwear that can provide, for example, improved manufacturability and/or improved customization. In particular, the articles of footwear disclosed herein comprise a segmented body that can be quickly and efficiently manufactured (e.g., in an additive manufacturing process, etc.), while allowing customizability in each of the different segments of the body.

In some examples, an article of footwear comprises a three-dimensionally printed body having a longitudinal axis extending from a forefoot region of the body to a heel region of the body, wherein the body comprises a plurality of discrete segments that are coupled together, wherein a first segment of the plurality of segments defines the forefoot region and a second segment of the plurality of segments defines the heel region, wherein each segment of the plurality of segments includes an opening extending in a direction parallel to the longitudinal axis; and a connection member disposed within the openings of the segments from the first segment to the second segment, wherein the connection member couples the plurality of segments together.

In certain examples, an article of footwear comprises a body comprising an upper configured to receive a wearer's foot and a sole structure configured to be disposed under the wearer's foot, wherein the body comprises a plurality of discrete segments including a forefoot segment and a heel segment, wherein the forefoot segment includes a forefoot portion of the upper and a forefoot portion of the sole structure, wherein the forefoot portions of the upper and the sole structure are integrally formed as a unitary structure, wherein the heel segment includes a heel portion of the upper and a heel portion of the sole structure, wherein the heel portions of the upper and the sole structure are integrally formed as a unitary structure; and at least one connection member extending between the forefoot segment and the heel segment, wherein the connection member is disposed in at least one opening of the plurality of segments.

In particular examples, an article of footwear comprises a body at least partially defining a foot-receiving cavity, wherein the body comprises a plurality of individual segments that are coupled together, wherein a first segment of the plurality of segments includes a posterior face extending in a superior/inferior direction and in a medial/lateral direction, wherein a second segment of the plurality of segments includes an anterior face extending in the superior/inferior direction and in the medial/lateral direction, wherein the first segment is positioned anterior to the second segment in an anterior/posterior direction, wherein each of the plurality of segments includes at least one opening positioned inferior to the foot-receiving cavity in the superior/inferior direction; and a connection member disposed within the openings of the segments from the first segment to the second segment in the anterior/posterior direction, wherein the connection member couples the plurality of segments together.

In some examples, a method of forming an article of footwear comprises printing a forefoot segment comprising a forefoot portion of an upper, a forefoot portion of a sole structure, and a first opening configured to receive a connection member; and printing a heel segment comprising a heel portion of the upper, a heel portion of the sole structure, and a second opening configured to receive the connection member.

In some examples, a method of forming an article of footwear comprises printing a first segment of a body of an article of footwear, the first segment comprising a first mating surface; and printing a second segment of the body of the article of footwear, the second segment comprising a second mating surface configured to mate with the first mating surface, wherein the first and second mating surfaces are oriented downwardly during printing.

These and other features, aspects, and/or advantages of the present disclosure will become better understood with reference to the following description and the claims. The accompanying drawings, which are incorporated in and constitute a part of this specification, illustrate examples of the disclosed technology and, together with the description, explain the principles of the disclosure.

An article of footwear typically includes two main components: a sole structure and an upper. The sole structure is configured for supporting the wearer's foot and providing cushioning between the wearer's foot and the ground. The upper is coupled to the sole structure and forms a foot-receiving cavity. The upper is configured for securing the wearer's foot to the sole structure and/or can protect the wearer's foot.

In some instances, an article of footwear can be manufactured using additive manufacturing processes. However, these processes can be time consuming when manufacturing an entire shoe. Thus, articles of footwear with improved manufacturability are desired.

Disclosed herein are articles of footwear that can provide, for example, improved manufacturability and/or improved customization. In particular, the articles of footwear disclosed herein comprise a segmented body that can be quickly and efficiently manufactured (e.g., in an additive manufacturing process, etc.), while allowing customizability in each of the different segments of the body.

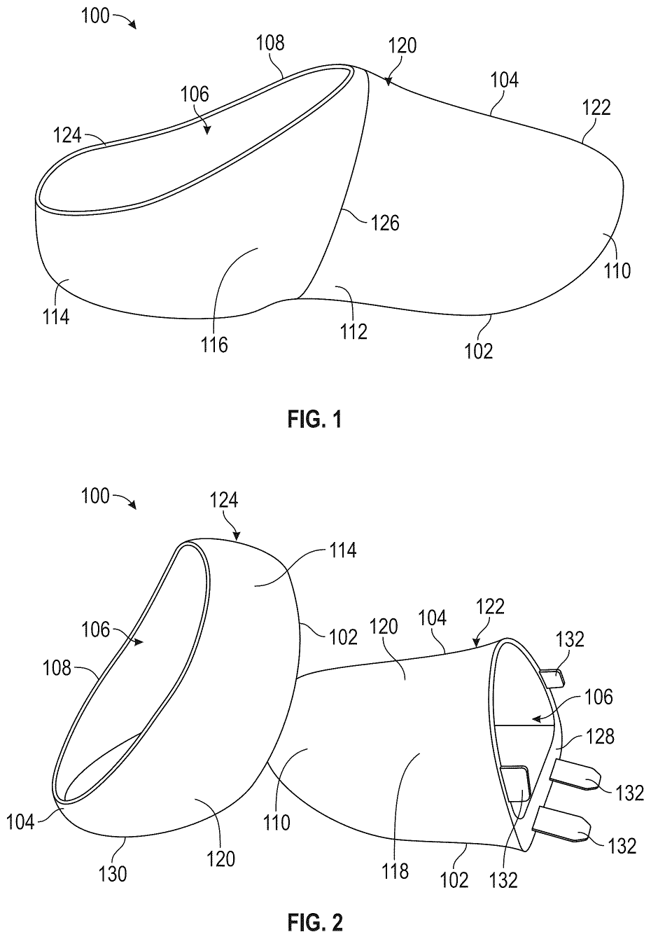

For example, FIGS. 1-2 depict an article of footwear 100, according to one example. The article of footwear 100 can also be referred to as “the article 100,” “the footwear 100,” or “the shoe 100.” FIG. 1 depicts perspective view of a lateral side of the article of footwear 100 (e.g., configured to be worn on a right foot of a wearer). FIG. 2 depicts a perspective view of the article of footwear 100, separated into segments.

Referring to FIGS. 1-2, a body 120 of the article of footwear 100 is divided into a plurality of discrete segments taken in a plane that is generally perpendicular to an anterior/posterior direction of the article of footwear 100. That is, the plane extends in a superior/inferior direction and a medial/lateral direction. For example, the body 120 includes a forefoot segment 122 that defines a forefoot portion 110 of the article of footwear 100 and a heel segment 124 that defines a heel portion 114 of the article of footwear 100. The forefoot portion 110 of the article of footwear 100 can correspond to anterior portions of a foot, including toes and joints connecting metatarsal bones with phalanx bones of the foot. The heel portion 114 of the article of footwear 100 can correspond with posterior portions of the foot, including a calcaneus bone. Accordingly, the body 120 of the article of footwear 100 can also be referred to as a “segmented body.”

In some examples, the forefoot segment 122 and the heel segment 124 can also partially define a midfoot portion 112. The midfoot portion 112 of the article of footwear 100 can correspond with an arch area of the foot. For example, a seam 126 is defined between the forefoot segment 122 and the heel segment 124 and the seam 126 (which can also be called a “joint”) can be positioned in the midfoot portion 112 of the article of footwear 100. The seam 126 is defined by a posterior face 128 of the forefoot segment 122 and an anterior face 130 of the heel segment 124. When the forefoot segment 122 and the heel segment 124 are coupled together, the posterior face 128 of the forefoot segment 122 abuts and/or is flush with the anterior face 130 of the heel segment 124. The posterior face 128 and the anterior face 130 extend in the superior/inferior direction and the medial/lateral direction.

As shown in FIGS. 1-2, the article of footwear 100 comprises a sole structure 102 and an upper 104, which are integrally formed (e.g., integrally formed with one another within each of the forefoot segment 122 and the heel segment 124). The upper 104 is coupled to and extends from the sole structure 102 thereby forming a foot-receiving cavity 106 between the sole structure 102 and the upper 104. The upper 104 defines a foot opening 108 that provides access to the foot-receiving cavity 106.

The body 120 includes both the sole structure 102 and the upper 104. Specifically, each of the forefoot segment 122 and the heel segment 124 includes a portion of the sole structure 102 and a portion of the upper 104. For example, the forefoot segment 122 includes the forefoot portion 110 of the sole structure 102 and the forefoot portion 110 of the upper 104, which are integrally formed together as a unitary structure. The heel segment 124 includes the heel portion 114 of the sole structure 102 and the heel portion 114 of the upper 104, which are integrally formed as a unitary structure.

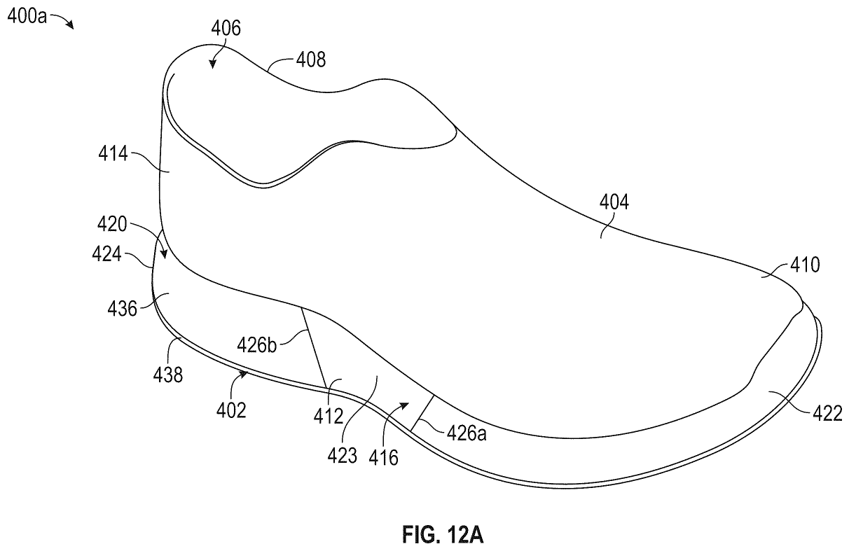

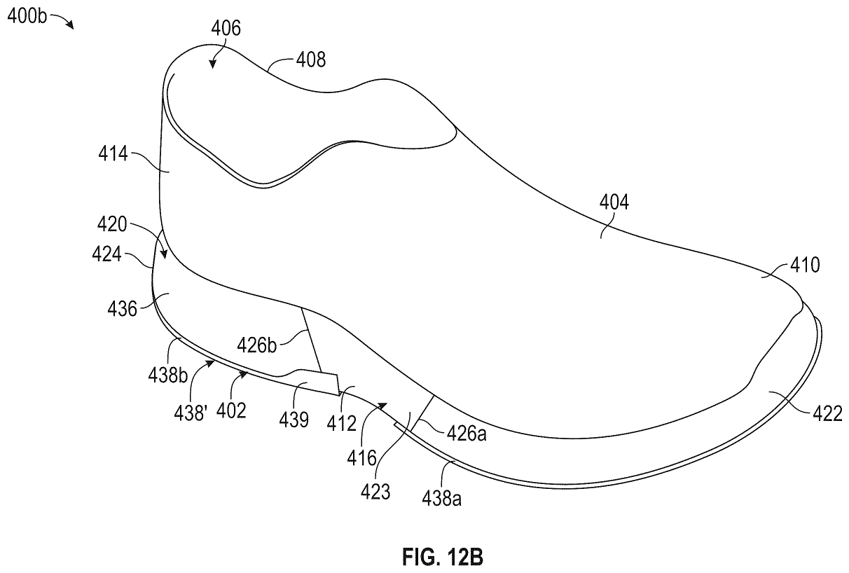

In the example of FIGS. 12A-12B, the heel segment 124 defines the foot opening 108, such that the entirety of the foot opening 108 is included in the heel segment 124. In other examples, multiple segments can define the foot opening 108 (e.g., the heel segment 124 can define a portion of the foot opening 108 and the forefoot segment 122 can define a portion of the foot opening 108).

The body 120 can comprise polymeric material. In some examples, the segments of the body 120 (e.g., the forefoot segment 122 and the heel segment 124) can comprise the same material. As used herein, the same material includes different densities of the material. For example, the forefoot segment 122 can comprise the same material throughout and the material can be a first density in the forefoot portion 110 of the sole structure 102 and a second, different density in the forefoot portion 110 of the upper 104. As another example, the forefoot segment 122 can comprise a first density of the material and the heel segment 124 can comprise a second, different density of the material.

In some examples, the segments of the body 120 can comprise different materials and/or different material properties. For example, the forefoot segment 122 can comprise a transparent material and the heel segment 124 can comprise an opaque material. In some examples, the forefoot segment 122 can comprise a relatively flexible polymeric material and the heel segment 124 can comprise a relatively rigid polymeric material.

In some examples, the body 120 of the article of footwear 100 can be formed using an additive manufacturing process, also referred to as three-dimensional printing (or simply “printing”). The terms “additive manufacturing” and “three-dimensional printing” refer to any device and technology for making a three-dimensional object through an additive process where layers of material are successively laid down under the control of a computer. Three-dimensional printing technologies can include fused deposition modeling (FDM), selective laser sintering (SLS), stereolithography (SLA), and the like. For example, each segment of the body 120 (e.g., the forefoot segment 122 and the heel segment 124) can be separately printed.

In some examples, the body 120 can comprise one or more printable materials. For example, printable materials can include thermoplastic materials such as thermoplastic polyurethanes (TPUs) (e.g., polyester-polyurethane copolymers and polyether-polyurethane copolymers, including thermoplastic elastomeric polyurethanes), thermoplastic polyolefins, thermoplastic polyether block amides (PEBAs), and combinations thereof.

Printing the body 120 in multiple segments can reduce production time, for example, when compared to printing the body 120 as a single component and can simplify the production process. Printing the segments individually can take less time to print than printing the body 120 as a single component. For example, each segment is smaller than the entire body 120, such that each of the segments takes less time to print than a larger component including the entire body 120. Further, it is possible to print different segments simultaneously which can also reduce production time. Moreover, printing the body 120 in multiple segments can eliminate the need to use external supports during the printing process. External supports are typically used to prevent sagging or collapsing during printing when a component has an overhang portion that extends out without any portion of the component directly beneath it. For example, if the body 120 were printed as a single component, external supports may be needed within the foot-receiving cavity 106 to support the upper 104. Significant time can be spent printing supports during the printing process. When the body 120 is printed in segments, the segments can be oriented such that the mating faces of the segments (e.g., the posterior face 128 of the forefoot segment 122 and the anterior face 130 of the heel segment 124) are positioned downwardly on a printing surface. When the segments are printed upwardly from the mating faces, each successive layer can be printed upon an existing surface, such that an extrinsic support is not needed beneath them. For example, the heel segment 124 is shown in this orientation in FIG. 2 with the anterior face 130 facing downwardly. In some examples, the division of the body 120 into multiple segments also provides increased customizability of the article of footwear 100.

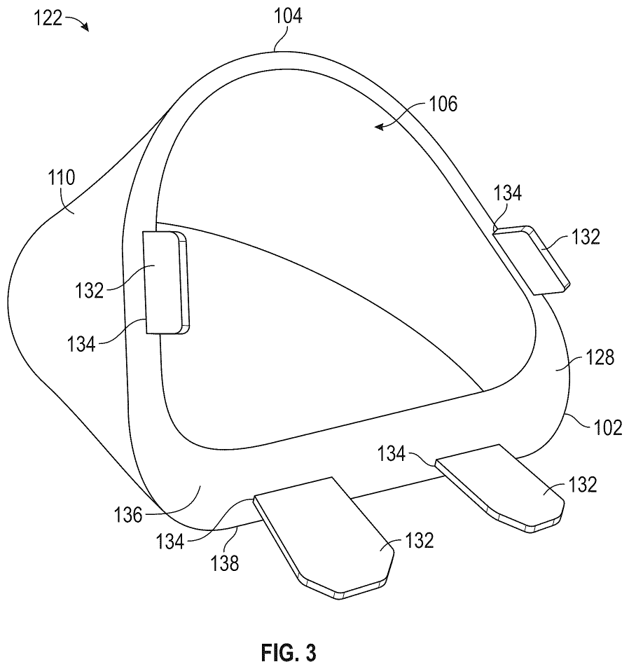

As shown in FIG. 3, the sole structure 102 of the article of footwear 100 comprises a midsole 136 and an outsole 138. FIG. 3 depicts a perspective view of the posterior face 128 of the forefoot segment 122 of the article of footwear 100. The midsole 136 of the sole structure 102 is configured to be positioned under the wearer's foot. As such, the midsole 136 can, for example, be configured to provide cushioning and support. The midsole 136 can be configured to flex and/or elastically deform as the wearer's foot applies pressure upon the midsole 136 and/or as the article of footwear 100 impacts a ground surface.

The outsole 138 of the sole structure 102 is configured to contact the ground surface. Accordingly, the outsole 138 can, for example, be configured to provide increased traction and/or to protect the other components of the sole structure 102 and/or the upper 104. In some examples, the outsole can comprise various traction elements (e.g., nubs, ribs, cleats, lugs, patterns, etc.) configured for engaging one or more types of ground surfaces.

The components of the sole structure 102 can be integrally formed as a unitary structure. Additionally, the components of the sole structure 102 and the upper 104 can be integrally formed as a unitary structure. For example, as shown in FIG. 3, the forefoot portion 110 of the midsole 136 and the forefoot portion 110 of the outsole 138 can be integrally formed together with the forefoot portion 110 of the upper 104 as a unitary structure. Similarly, the heel portion 114 of the midsole 136 and the heel portion 114 of the outsole 138 can be integrally formed together with the heel portion 114 of the upper 104 as a unitary structure.

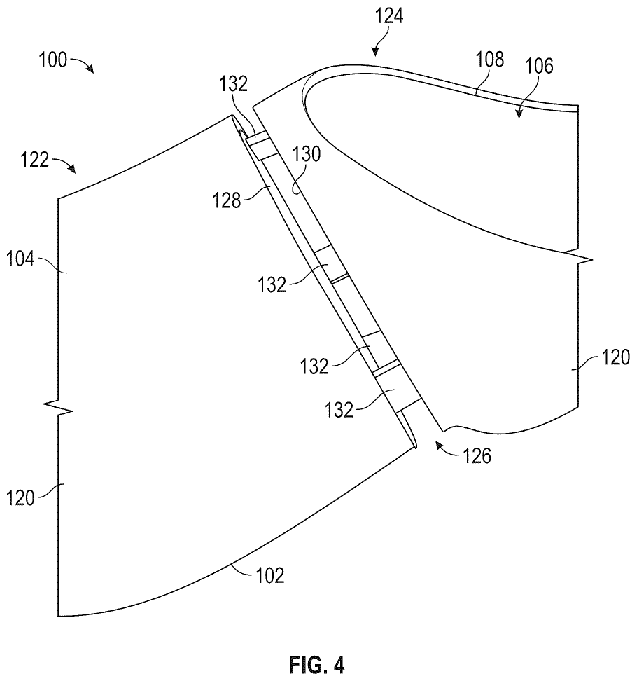

The forefoot segment 122 and the heel segment 124 are coupled together at the seam 126 by at least one connection member 132. For example, as shown in FIGS. 2-4, multiple connection members 132 (e.g., four) extend between the forefoot segment 122 and the heel segment 124 to couple the segments together. It should be appreciated that a different number of connection members 132 (e.g., one, two, etc.) can be used to couple the segments of the article of footwear 100 together. FIG. 4 depicts a partial perspective view of the article of footwear 100 with the forefoot segment 122 partially separated from the heel segment 124.

The connection members 132 are disposed within and extend through openings 134 in the forefoot segment 122 and the heel segment 124. The openings 134 are sized and shaped to receive the connection members 132. The openings 134 extend in a direction parallel to a longitudinal axis of the body 120 (e.g., extending between the toe and the heel of the article of footwear 100). In this way, the openings 134 are generally perpendicular to the posterior face 128 of the forefoot segment 122 and the anterior face 130 of the heel segment 124.

The openings 134 can be spaced apart around the body 120. For example, as shown in FIG. 3, two of the openings 134 are disposed in the upper 104 and two of the openings 134 are disposed in the sole structure 102 (e.g., in the midsole 136). In some examples, as shown, the openings 134 are disposed within the upper 104 and the sole structure 102, such that a portion of the upper 104 and a portion of the sole structure 102 surrounds the openings 134. In some examples, the openings 134 are configured as recesses within the body 120, such that a portion of the body 120 (e.g., a portion of the sole structure 102) partially surrounds the openings 134. In some examples, the openings 134 are only disposed in the sole structure 102. In some examples, the openings 134 are only disposed in the upper 104. In this way, the connection members 132 can be positioned in the upper 104 and/or the sole structure 102 within the openings 134.

The connection members 132 can comprise cylindrical structures such as rods, tubes, or shafts, rectangular structures such as plates, and/or other elongate structures such as irregularly-shaped or non-uniformly-shaped structures for joining segments together. The connection members 132 can comprise a metallic material, a polymeric material, and/or a composite material. In some examples, the connection members 132 can be printed. In some examples, the connection members 132 can provide a desired amount of flex between the segments of the body 120, based on the material and/or configuration of the connection members 132. In some examples, the connection members 132 can be configured to increase the stiffness and/or rigidity of the article of footwear 100. For example, a relatively rigid material can be used for the connection member 132 (e.g., more rigid than the material of the body 120).

In some examples, the connection members 132 can be at least partially received within one another. For example, one or more inner connection members (e.g., a rod, a tube, etc.) can be disposed within an outer connection member (e.g., a hollow rod or tube, etc.), such as in a concentric arrangement. Various inner connection members can be disposed within the outer connection member to allow modification of the stiffness of the article of footwear 100. For example, the inner connection members can comprise materials having different stiffnesses, such that the stiffness of the article of footwear 100 can be modified depending on the inner connection member used with the article of footwear 100. In some examples, the inner connection member comprises a material that has a greater stiffness than the material of the outer connection member.

The connection members 132 couple the segments of the body 120 (e.g., the forefoot segment 122 and the heel segments 124) by friction fit. For example, the connection members 132 can couple the segments of the body 120 together without the use of adhesive. In some examples, the connection members 132 can include an engagement structure such as a shoulder, ramp, protrusion, latch, barb, tooth, and/or tab that grips the inside of the opening 134. Additionally, or alternatively, each opening 134 can be configured (e.g., shaped) in a manner to restrict and/or prevent removing the corresponding connection member 132 from the opening 134. For example, each opening 134 can have a stepped inner surface and/or a tapered cross-sectional profile to frictionally engage the corresponding connection member 132. In some examples, the connection members 132 can couple the segments of the body 120 together in a locking manner, such that the segments are non-separatable after initial assembly. In some examples, the connection members can couple the segments of the body 120 together in a non-locking manner, such that the segments are able to be non-destructively disassembled. In some examples, the engagement structure of the connection member 132 can be selectively disengaged, such that the connection member 132 can operate in the non-locking manner. In some examples, adhesive can be used in addition (or as an alternative) to the connection members 132 to couple the segments of the body 120 together.

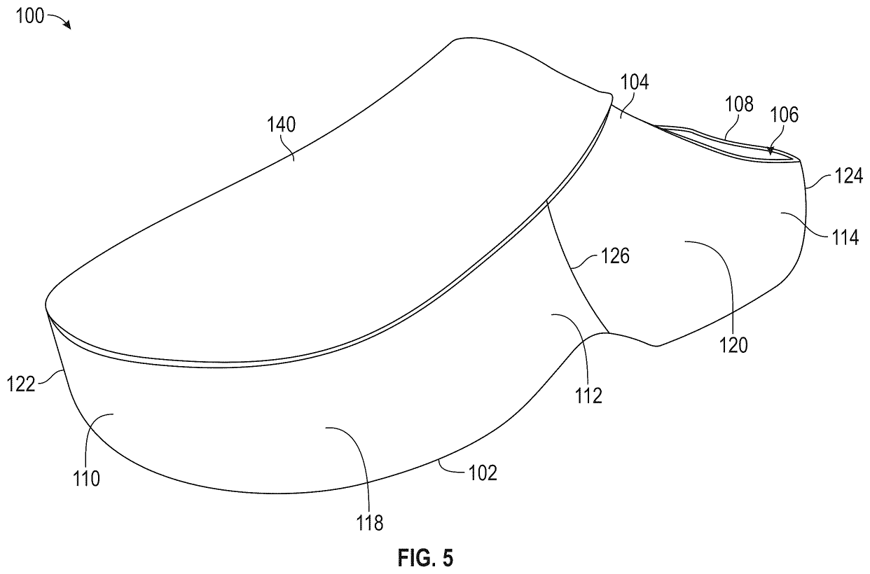

As shown in FIG. 5, the article of footwear 100 can include an optional cover 140 that is coupled to the body 120 (e.g., superior to the upper 104). The cover 140 can be formed of various materials. For example, the cover 140 can be formed of one or more of the following materials: textiles, foam, leather, polymers, and/or synthetic leather. In some examples, the cover 140 can be formed as a single, unitary component (e.g., by knitting, printing, or molding). In other examples, the cover 140 can comprise a plurality of components that are coupled together (e.g., by stitching, adhesive, fasteners, etc.).

The cover 140 can be coupled to the body 120 in various ways. For example, the cover 140, the forefoot segment 122, and/or the heel segment 124 can be coupled together with adhesive, fasteners, stitching, and/or other means for coupling. In some examples, the cover 140 can partially or fully obscure the seam 126 from view and/or further couple the segments of the body 120 together.

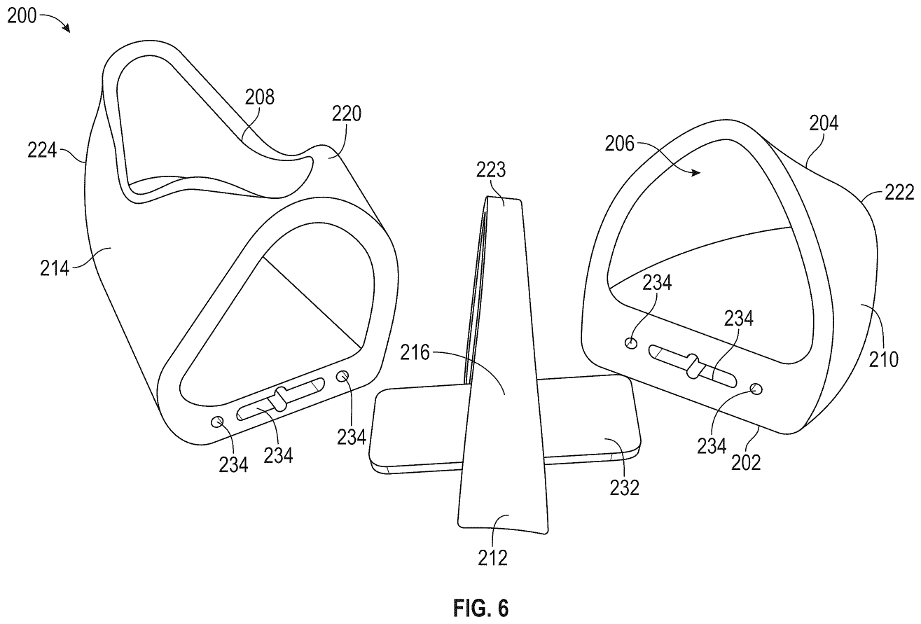

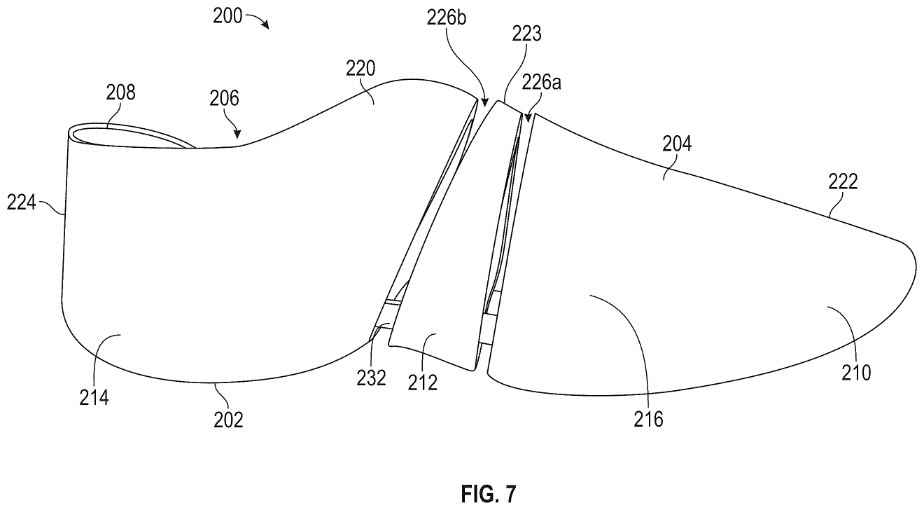

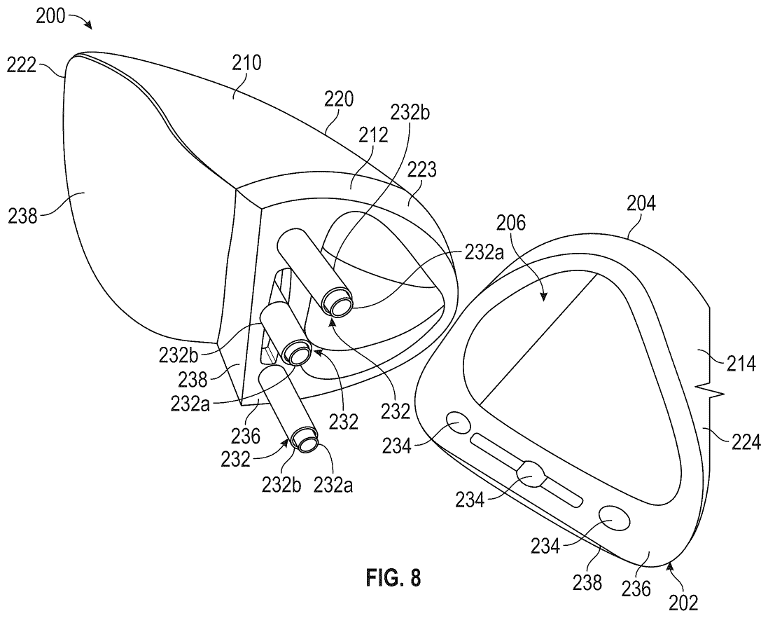

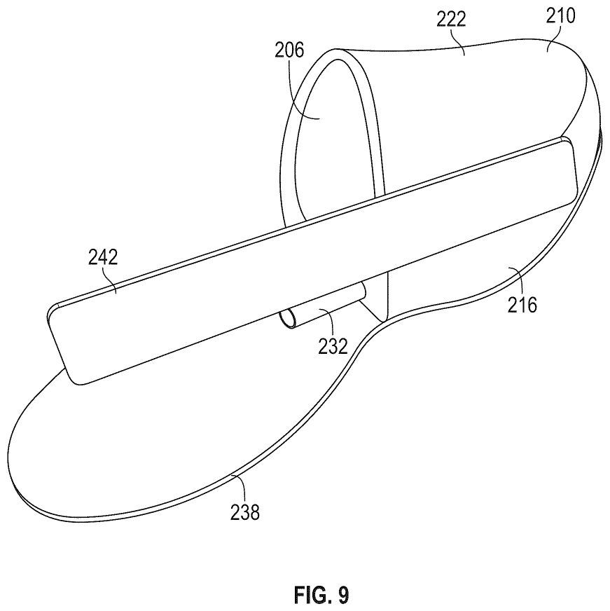

As described above, the body 120 of the article of footwear 100 is divided into two discrete segments. FIGS. 6-8 show an article of footwear 200 having a body 220 that is divided into three discrete segments. Similar to article of footwear 100, article of footwear 200 includes a sole structure 202 associated with an upper 204. Sole structure 202 may have generally the same configuration as sole structure 102 discussed above. Upper 204 may have generally the same configuration as upper 104 discussed above. Similar to article of footwear 100, the article of footwear 200 includes a foot-receiving cavity 206 and a corresponding foot opening 208. Similar to article of footwear 100, the article of footwear 200 includes a forefoot portion 210, a midfoot portion 212, and a heel portion 214. FIG. 6 depicts a perspective view of a lateral side of the article of footwear 200 (e.g., configured to be worn on a right foot of a wearer), with the article of footwear 200 separated into segments. FIG. 7 depicts an elevation view of the lateral side of the article of footwear 200. FIG. 8 depicts a perspective view of the article of footwear 200 separated into segments.

As shown in FIGS. 6-8, the body 220 of the article of footwear 200 can divided into a different number of discrete segments (e.g., three, four, five, etc.) taken in a plane that is generally perpendicular to an anterior/posterior direction of the article of footwear 200. For example, the body 220 includes a forefoot segment 222 that defines the forefoot portion 210 of the article of footwear 200, a midfoot segment 223 that defines the midfoot portion 212 of the article of footwear 200, and a heel segment 224 that defines the heel portion 214 of the article of footwear 200.

As shown in FIG. 7, an anterior seam 226a is defined between the forefoot segment 222 and the midfoot segment 223 and a posterior seam 226b is defined between the midfoot segment 223 and the heel segment 224. When the segments of the body 220 are coupled together, the faces of the segments that define the seams 226a, 226b abut each other and can be flush.

Similar to the segments of the body 120, the segments of the body 220 can each be integrally formed as unitary structures. For example, the forefoot segment 222 includes the forefoot portion 210 of the sole structure 202 and the forefoot portion 210 of the upper 204, which are integrally formed as a unitary structure. The midfoot segment 223 includes the midfoot portion 212 of the sole structure 202 and the midfoot portion 212 of the upper 204, which are integrally formed as a unitary structure. The heel segment 224 includes the heel portion 214 of the sole structure 202 and the heel portion 214 of the upper 204, which are integrally formed as a unitary structure.

Similar to heel segment 124, the heel segment 224 defines the foot opening 208 that provides access to the foot-receiving cavity 206.

Similar to article of footwear 100, the article of footwear 200 includes a connection member 232 that is received within corresponding openings 234. As shown in FIG. 6, the connection member 232 can be configured as a plate that extends through openings 234 in the forefoot segment 222, the midfoot segment 223, and the heel segment 224.

In some examples, the openings 234 can be configured to receive multiple types of connection members 232. For example, each segment of the body 220 includes a central opening 234 that is shaped to receive either a rectangular connection member 232 (e.g., having a rectangular or generally rectangular cross-section, such as a plate, etc.) or a cylindrical connection member 232 (e.g., a rod, a tube, a shaft, etc.). In some examples, as shown, each segment of the body 220 can also include openings 234 on either side of the central opening 234 which are shaped to receive a cylindrical connection member 232. As such, the segments of the body 220 can be coupled together with a variety of types of connection members 232. For example, a single rectangular connection member 232 can be used to couple the segments of the body 220 together, as shown in FIG. 6. In some examples, one or more cylindrical connection members 232 can be used to couple the segments of the body 220 together, as shown in FIG. 8. In some examples, a rectangular connection member 232 and one or more cylindrical connection members 232 can be used to couple the segments of the body 220 together.

As shown in FIG. 8, each connection member 232 optionally can include a cylindrical outer connection member 232a and a cylindrical inner connection member 232B received within the outer connection member 232a. The outer connection member 232a also may be referred to as an outer rod 232a and/or the inner connection member 232b also may be referred to as an inner rod 232b. As discussed above, such an arrangement can allow for modification of the stiffness of the article of footwear 200, such as via modification of the stiffness of the inner connection members 232a and/or the outer connection members 232b. In an example in which the inner connection members 232b are omitted, the outer connection members 232a may be referred to as the connection members 232.

In the example of FIG. 8, each inner connection member 232b is concentric with the corresponding outer connection member 232a. This is not required of all examples, however, and it additionally is within the scope of the present disclosure that the inner connection members 232b may be off-center relative to the corresponding outer connection members 232a. Additionally, while FIG. 8 illustrates each inner connection member 232b as extending partially out of the corresponding outer connection member 232a, it also is within the scope of the present disclosure that each outer connection member 232a may be axially coextensive with the corresponding inner connection member 232b and/or that each inner connection member 232b is fully received within the corresponding outer connection member 232a.

Similar to connection members 132, the connection members 232 can couple the segments of the body 220 together in a locking manner and/or in a non-locking manner. In some examples, the connection members 232 can include engagement structure(s), such as those described above. In some examples, adhesive can be used in addition (or alternative) to the connection members 232 to couple the segments of the body 220 together.

In some examples, the connection members 232 and the segments of the body 220 are replaceable and/or interchangeable, such that the connection members 232 and the segments of the body 220 can be non-destructively separated. In this manner, one or more segments of the body 220 can be removed from the connection members 232, such that the segment(s) can be interchanged and/or replaced with one or more different segments. In some examples, some of the connection members 232 and the segments of the body 220 are replaceable and/or interchangeable, such that a subset of the connection members 232 and/or the segments of the body 220 can be non-destructively separated. In some examples, none of the connection members 232 and none of the segments of the body 220 are replaceable and/or interchangeable, such that the connection members 232 and the segments of the body 220 cannot be non-destructively separated.

Similar to the sole structure 102, the sole structure 202 includes a midsole 236 and an outsole 238, as shown in FIG. 8. In some examples, the components of the sole structure 102 can be formed separately and coupled together. For example, the midsole 236 and the upper 104 can be integrally formed as a unitary structure in each segment of the body 220 and the outsole 238 can be formed separately and coupled thereto. For example, as shown in FIG. 8, the forefoot portion 210 of the midsole 236 and the forefoot portion 210 of the upper 204 can be integrally formed as a unitary structure and the forefoot portion 210 of the outsole 238 can be coupled thereto. Similarly, the heel portion 214 of the midsole 236 and the heel portion 214 of the upper 204 can be integrally formed as a unitary structure and the heel portion 214 of the outsole 238 can be coupled thereto.

In some examples, the outsole 238 can comprise one or more relatively flexible polymeric materials (e.g., thin rubber). In other examples, the outsole 238 can comprise one or more relatively rigid polymeric materials (e.g., TPU).

The outsole 238 can be coupled to the segments of the body 220 in various ways. For example, in some instances, the midsole 236 and the outsole 238 can be coupled together with adhesive, fasteners, stitching, over-molding, co-molding, and/or other means for coupling.

In some examples, as shown in FIG. 8, the outsole 238 (and/or portions thereof) can be integrally formed with one or more of the segments (e.g., the midfoot segment 223), while being formed separately from other one(s) of the segments (e.g., the forefoot segment 222 and the heel segment 224) and subsequently coupled thereto. In some examples, as shown in FIG. 9, the outsole 238 can be separately formed as a single, unitary component and coupled to each of the segments of the body 220, rather than being divided into segments. FIG. 9 depicts a perspective view of the lateral side of the article of footwear 200, with the midfoot segment 223 and the heel segment 224 removed for purposes of illustration.

As shown in FIG. 9, the article of footwear 200 can include an optional side member 242 that is coupled to a lateral side portion 216 of the body 220. In some examples, side member(s) 242 can be coupled to the lateral side portion 216 and/or a medial side portion 218 of the body 220. In some examples, the lateral side portion 216 and/or the medial side portion 218 of the body 220 can include a recess for receiving a side member 242. The side member 242 can comprise a polymeric material, and in some examples, the side member 242 can comprise the same material as the segments of the body 220.

The side member 242 can be coupled to the body 220 in various ways. For example, the side member 242, the forefoot segment 222, the midfoot segment 223, and/or the heel segment 224 can be coupled together with adhesive, fasteners, stitching, and/or other means for coupling. In some examples, the side member 242 can at least partially obscure the seams 226a, 226b from view and further couple the segments of the body 220 together.

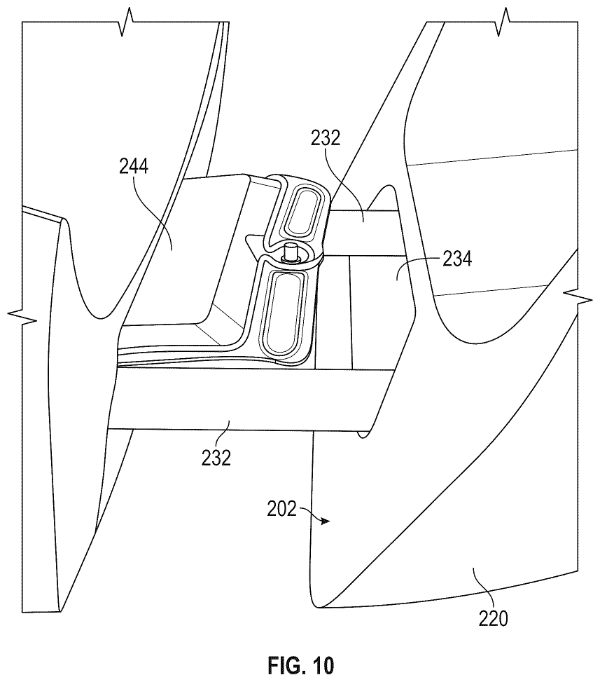

In some examples, the sole structure 202 can include one or more additional components. For instance, as shown in FIG. 10, the sole structure 202 comprises a cushioning element 244. Various types of cushioning elements can be used. For example, the cushioning element 244 can be a fluid-filled capsule (e.g., airbag). As another example, the cushioning element 244 can be a foam pad. As yet another example, the cushioning element can include a plurality of bead-like members contained within a flexible membrane.

In particular implementations, the sole structure can include one or more additional components (e.g., one or more additional cushioning elements) and/or omit one or more of the components of the sole structure (e.g., there may be only one cushioning element, or there may be no cushioning elements).

In certain examples, the openings 234 in the segments of the body 220, which receive the connection members 232, can be configured to receive one or more cushioning elements 244. For instance, referring still to FIG. 10, the openings 234 of the segments of the body 220 are sized and shaped to receive a cushioning element 244 and multiple connection members 232. In some examples, the cushioning element 244 can be disposed in an opening 234 that is separate from opening(s) 234 for the one or more connection members 232.

As described above, a body of an article of footwear (e.g., article of footwear 100, article of footwear 200) is divided into a plurality of discrete segments and, in some examples, can include both a sole structure and an upper. In some examples, the upper can be formed separately from the body and coupled thereto. As such, in some examples, the body of the article of footwear includes one or more components of the sole structure and not the upper.

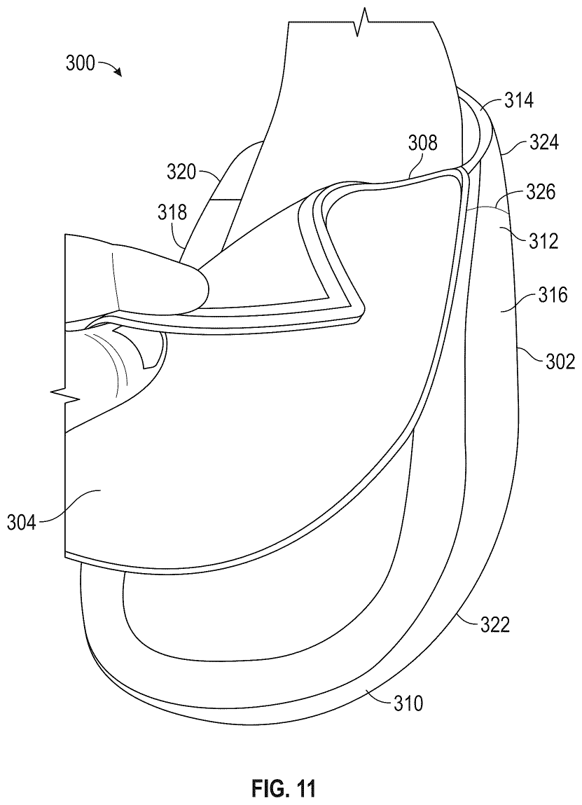

FIG. 11 shows an article of footwear 300 having an upper 304 that is formed separately and coupled to a body 320 that is divided into multiple discrete segments. Similar to article of footwear 100, article of footwear 300 includes a sole structure 302. Sole structure 302 may have generally the same configuration as sole structure 102 discussed above. Similar to article of footwear 100, the article of footwear 300 includes a foot opening 308 that provides access to a foot-receiving cavity. Similar to article of footwear 100, the article of footwear 300 includes a forefoot portion 310, a midfoot portion 312, and a heel portion 314. FIG. 11 depicts a perspective view of the forefoot portion of the article of footwear 300.

Similar to body 120, the body 320 is divided into a forefoot segment 322 that defines the forefoot portion 310 of the article of footwear 300 and a heel segment 324 that defines the heel portion 314 of the article of footwear 300. The forefoot segment 322 and the heel segment 324 also partially define the midfoot portion 312, such that a seam 326 is defined between the forefoot segment 322 and the heel segment 324 and is positioned in the midfoot portion 312 of the article of footwear 300.

Similar to the articles of footwear described herein (e.g., footwear 100, footwear 200, etc.), the forefoot segment 322 and the heel segment 324 are coupled together with one or more connection members (e.g., connection members 132, connection members 232) positioned within one or more openings (e.g., openings 134, openings 234).

As shown in FIG. 11, the body 320 includes the sole structure 302. Specifically, each of the forefoot segment 322 and the heel segment 324 includes a portion of the sole structure 302. For example, the forefoot segment 322 includes the forefoot portion 310 of the sole structure 302. The heel segment 324 includes the heel portion 314 of the sole structure 302.

The upper 304 is formed separately from the body 320 (e.g., both by printing) and coupled thereto. The upper 304 can be fixedly coupled to the body 320 in various ways. The upper 304 can be attached (e.g., stitched) to a strobel, and the strobel can be attached to a midsole of the sole structure 302 (e.g., with an adhesive). In other examples, the strobel can be omitted, and the upper 304 can be attached to a component of the sole structure 302. In some such examples, the upper 304 can be directly attached to a midsole and/or a cushioning element (e.g., an airbag) of the sole structure 302 via adhesive, stitching, and/or other means for coupling. In some examples, the upper 304 can be coupled to the sole structure 302 via mating features positioned on the upper 304 and corresponding mating features positioned on the sole structure 302.

The upper 304 of the footwear 300 can be formed of various materials. For example, the upper 304 can be formed of one or more of the following materials: textiles, foam, leather, polymers, and/or synthetic leather. In some examples, the upper 304 can be 3D printed. In some examples, the upper 304 can be formed as a single, unitary component (e.g., by knitting or molding). In other examples, the upper 304 can comprise a plurality of components that are coupled together (e.g., by stitching, adhesive, fasteners, connection members, etc.). For example, the upper 304 can be divided in the anterior/posterior direction into segments (e.g., similar to body 320) and the segments of the upper 304 can be coupled together with connection members (e.g., connection members 132, etc.).

As shown in FIG. 11, the heel segment 324 partially defines the foot opening 308 and the upper 304 partially defines the foot opening 308. In some examples, the upper 304 can fully define the foot opening 308.

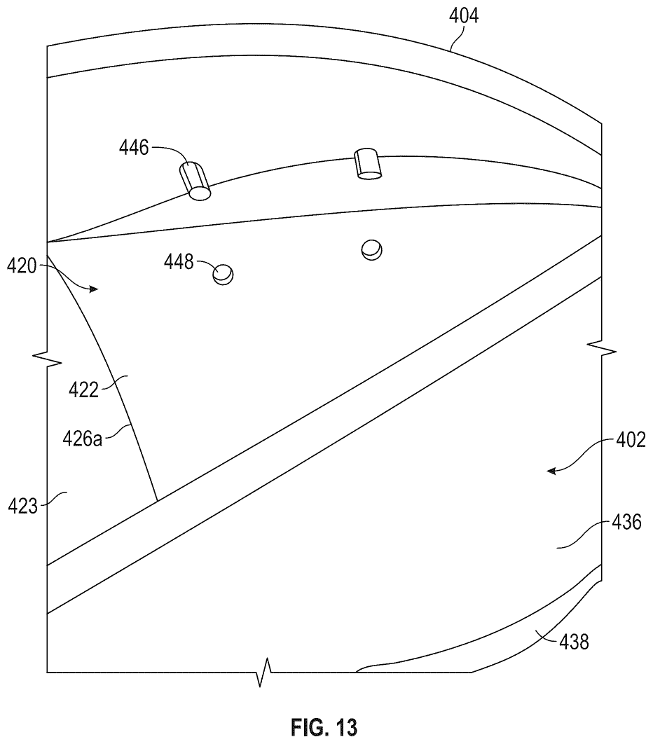

FIG. 12A and 13 show an article of footwear 400a having an upper 404 that is formed separately and coupled to a body 420 that is divided into multiple discrete segments, similar to article of footwear 300. Upper 404 may have generally the same configuration as upper 304 discussed above. Similar to article of footwear 100, article of footwear 400a includes a sole structure 402. Sole structure 402 may have generally the same configuration as sole structure 102 discussed above and include a midsole 436 and an outsole 438. Similar to article of footwear 100, the article of footwear 400a includes a foot-receiving cavity 406 and a corresponding foot opening 408. Similar to article of footwear 100, the article of footwear 400a includes a medial side portion (not visible in FIG. 12A), a lateral side portion 416, a forefoot portion 410, a midfoot portion 412, and a heel portion 414. FIG. 12A depicts a perspective view of a lateral side of the article of footwear 400a (e.g., configured to be worn on a right foot of a wearer). FIG. 13 depicts a partial perspective view of the upper 404 partially separated from the sole structure 402.

Similar to body 220, the body 420 is divided into a forefoot segment 422 that defines the forefoot portion 410 of the article of footwear 400a, a midfoot segment 423 that defines the midfoot portion 412 of the article of footwear 400a, and a heel segment 424 that defines the heel portion 414 of the article of footwear 400a. As shown in FIG. 12A, an anterior seam 426a is defined between the forefoot segment 422 and the midfoot segment 423 and a posterior seam 426b is defined between the midfoot segment 423 and the heel segment 424. When the segments of the body 420 are coupled together, the faces of the segments that define the seams 426a, 426b abut each other and are flush with one another. Similar to the articles of footwear described herein, the forefoot segment 422, the midfoot segment 423, and the heel segment 424 are coupled together with one or more connection members (e.g., connection members 132, connection members 232, etc.) positioned within one or more openings (e.g., openings 134, openings 234, etc.).

As shown in FIG. 12A, the segmented body 420 includes the midsole 436. Specifically, each of the forefoot segment 422, the midfoot segment 423, and the heel segment 424 includes a portion of the midsole 436. For example, the forefoot segment 422 includes the forefoot portion 410 of the midsole 436. The midfoot segment 423 includes the midfoot portion 412 of the midsole 436. The heel segment 424 includes the heel portion 414 of the midsole 436.

In the example of FIG. 12A, the outsole 438 is formed separately from the body 420 as a single, unitary component and is coupled to the body 420 (e.g., to the midsole 436). In other examples, such as in the example of FIG. 12B discussed below, the outsole 438 can comprise a plurality of components that are coupled to one or more of the segments of the body 420. In some examples, the outsole 438 can comprise one or more relatively flexible polymeric materials (e.g., thin rubber). In other examples, the outsole 438 can comprise one or more relatively rigid polymeric materials (e.g., TPU) and/or metallic materials (e.g., steel).

The outsole 438 can be coupled to the body 420 in various ways. For example, in some instances, the midsole 436 and the outsole 438 can be coupled together with adhesive, fasteners, stitching, over-molding, co-molding, and/or other means for coupling. In some examples, such as in the example of FIG. 12A, the outsole 438 is coupled to multiple different portions and/or segments of the midsole 436 such that the outsole 438 operates to reinforce the connections between the portions and/or segments of the midsole 436. For example, in the example of FIG. 12A, the outsole 438 is coupled to each of the forefoot portion 410 of the midsole 436, the midfoot portion 412 of the midsole 436, and the heel portion 414 of the midsole 436. The outsole 438 thus extends across the anterior seam 426a to reinforce the coupling between the forefoot portion 410 and the midfoot portion 412. Similarly, the outsole 438 extends across the posterior seam 426b to reinforce the coupling between the midfoot portion 412 and the heel portion 414.

FIG. 12B shows an article of footwear 400b that is substantially identical to the article of footwear 400a of FIG. 12A. In the example of FIG. 12B, however, the sole structure 402 includes an outsole 438′ that includes a first outsole portion 438a and a second outsole portion 438b. The first outsole portion 438a and the second outsole portion 438b in this example are formed separately from one another and are spaced apart from one another on the article of footwear 400b.

The first outsole portion 438a is coupled to each of the forefoot portion 410 of the midsole 436 and the midfoot portion 412 of the midsole 436, while the second outsole portion 438b is coupled to each of the midfoot portion 412 of the midsole 436 and the heel portion 414 of the outsole. Accordingly, the first outsole portion 438a additionally or alternatively may be referred to as a forefoot outsole portion 438a and/or an anterior outsole portion 438a. Similarly, the second outsole portion 438b additionally or alternatively may be referred to as a heel outsole portion 438b and/or a posterior outsole portion 438b.

The first outsole portion 438a extends across the anterior seam 426a to reinforce the coupling between the forefoot portion 410 and the midfoot portion 412. Similarly, the second outsole portion 438b extends across the posterior seam 426b to reinforce the coupling between the midfoot portion 412 and the heel portion 414. In the example of FIG. 12B, the second outsole portion 438b additionally includes an outsole extension 439 that extends in a superior direction over the posterior seam 426b on the lateral side portion 416 to further reinforce the coupling between the midfoot portion 412 and the heel portion 414. The second outsole portion 438b additionally or alternatively can include a corresponding outsole extension 439 extending over the posterior seam 426b on the medial side portion (hidden in the view of FIG. 12B). In other examples, the first outsole portion 438a additionally or alternatively can include similar outsole extensions 439 extending in a superior direction over the anterior seam 426a on the lateral side portion 416 and/or the medial side portion to further reinforce the coupling between the forefoot portion 410 and the midfoot portion 412.

The upper 404 is formed separately from the body 420 and coupled thereto. The upper 404 can be fixedly coupled to the body 420 in various ways, such as those described above in connection with upper 304. As shown in FIG. 13, the upper 404 can be coupled to the sole structure 402 via mating features 446 positioned on the upper 404 and corresponding mating features 448 positioned on the sole structure 402. In the illustrated example, the mating features 446 comprise projections (e.g., pegs) that extend from an inferior surface of the upper 404 and the corresponding mating features 448 comprise openings through the sole structure 402 (e.g., through the midsole 436) that receive the projections 446. While two openings 448 are shown in the forefoot segment 422 of the body 420, it should be appreciated that each of the segments of the body 420 may include one or more openings 448 that correspond with projections 446 of the upper 404.

The upper 404 of the footwear 400 can be formed of various materials, such as those described above in connection with upper 304. The upper 404 can define the foot opening 408, as shown in FIGS. 12A-12B. In some examples, the article of footwear 400 also includes a closure system to adjust the foot-receiving cavity 406. In this manner, the closure system can be used, for example, to secure/release the article of footwear 400 to/from a wearer's foot. Exemplary closure systems include laces, straps, bands, cables, cords, ratcheting mechanisms, hook-and-loop, etc.

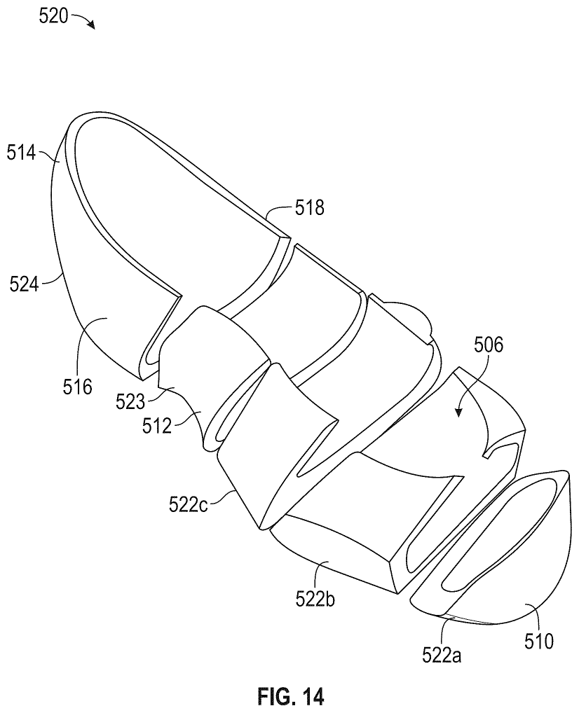

Any of the segmented bodies discussed herein (e.g., body 120, body 220, body 320, body 420, etc.) can be divided into a different number of segments. For example, each of body 120 and body 320 comprise two segments (e.g., a forefoot segment and a heel segment), and each of body 220 and body 420 comprise three segments (e.g., a forefoot segment, a midfoot segment, and a heel segment). FIG. 14 depicts a perspective view of a lateral side of the body 520 (e.g., configured to be worn on a right foot of a wearer). In some examples, a body 520 can include a greater number of segments, such as five, as shown in FIG. 14. An ordinarily skilled artisan will recognize, based on this description, that the number of segments can alternatively be any number in the range of two (2) to approximately twenty (20) segments, although the benefits of such construction may be improved when the number of segments is in the range of two (2) to ten (10) segments, or more particularly in the range of two (2) to five (5) segments.

Similar to other segmented bodies described herein, the body 520 includes a forefoot portion 510, a midfoot portion 512, and a heel portion 514. The body 520 also partially defines a foot-receiving cavity 506.

The body 520 comprises a sole structure 502, similar to other sole structures described herein. In some examples, an upper (e.g., upper 304, upper 404) can be formed separately from the body 520 and coupled thereto, as described above in connection with article of footwear 300 and article of footwear 400. In some examples, the body 520 can include an upper (e.g., similar to body 120, body 220, etc.), such that each segment of the body 520 is integrally formed as a unitary structure with a portion of the sole structure 502 and a portion of the upper.

As shown in FIG. 14, the body 520 is divided in the anterior/posterior direction into a first forefoot segment 522a, a second forefoot segment 522b, a third forefoot segment 522c, a midfoot segment 523, and a heel segment 524. Together, the first forefoot segment 522a, the second forefoot segment 522b, and the third forefoot segment 522c (collectively, the forefoot segments 522a-522c) define the forefoot portion 510 of the body 520. The midfoot segment 523 defines the midfoot portion 512 and the heel segment 524 defines the heel portion 514 of the body 520.

Similar to other segmented bodies described herein, the forefoot segments 522a-522c, the midfoot segment 523, and the heel segment 524 are configured to be coupled together with one or more connection members (e.g., connection members 132, connection members 232, etc.) positioned within one or more openings (e.g., openings 134, openings 234, etc.). Connection member(s) and opening(s) are omitted from the body 520 in FIG. 14 for purposes of illustration.

In some examples, one or more of the segments can fully extend around the foot-receiving cavity 506, while other segments extend partially around the foot-receiving cavity 506. For example, the first forefoot segment 522a extends around the foot-receiving cavity 506 and defines both the superior and inferior portions of the foot-receiving cavity 506. In some examples, such as when a separate upper is coupled to the body 520, the upper may not be coupled with a segment that fully extends around the foot-receiving cavity 506 (e.g., first forefoot segment 522a).

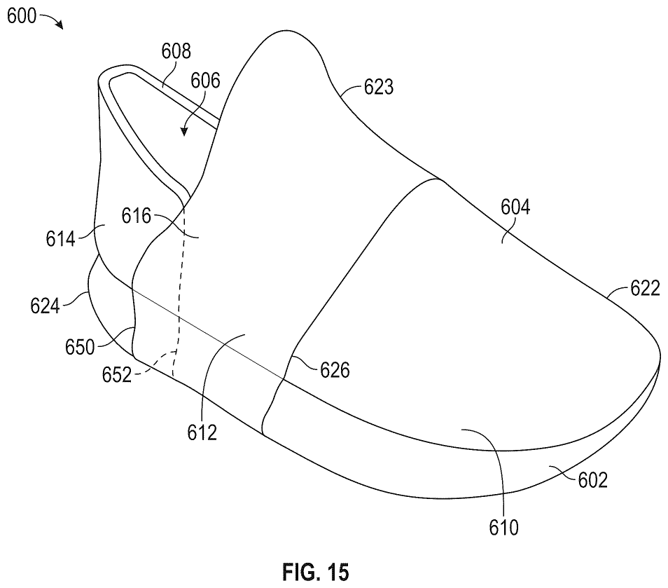

As described above, when segments of a body of an article of footwear are coupled together (e.g., with connection members), the faces of the segments can abut and be flush with one another in some examples. FIG. 15 shows an article of footwear 600 having a body 620 with segments that partially overlap, such that the faces do not abut each other. Similar to article of footwear 200, article of footwear 600 includes a sole structure 602 associated with an upper 604. Sole structure 602 may have generally the same configuration as sole structure 202 discussed above. Upper 604 may have generally the same configuration as upper 204 discussed above. Similar to article of footwear 200, the article of footwear 600 includes a foot-receiving cavity 606 and a corresponding foot opening 608. Similar to article of footwear 200, the article of footwear 600 includes a forefoot portion 610, a midfoot portion 612, and a heel portion 614. Similar to article of footwear 200, the article of footwear 600 includes a body 620 divided into a forefoot segment 622, a midfoot segment 623, and a heel segment 624. FIG. 15 depicts a perspective view of a lateral side of the article of footwear 600 (e.g., configured to be worn on a right foot of a wearer).

As shown in FIG. 15, a seam 626 is defined between the forefoot segment 622 and the midfoot segment 623. The seam 626 is defined by a posterior face of the forefoot segment 622 and an anterior face of the midfoot segment 623. When the forefoot segment 622 and the midfoot segment 623 are coupled together (e.g., with connection members 132, connection members 232, etc.), the posterior face of the forefoot segment 622 abuts and/or is flush with the anterior face of the midfoot segment 623.

When the midfoot segment 623 and the heel segment 624 are coupled together (e.g., with connection members), a posterior edge 650 of the midfoot segment 623 and an anterior edge 652 of the heel segment 624 are not flush with each other. A portion of the anterior edge 652 of the heel segment 624 is shown in dashed line for purposes of illustration. Instead, the posterior edge 650 of the midfoot segment 623 and the anterior edge 652 of the heel segment 624 overlap in the lateral and longitudinal directions. In some examples, this overlapping can more securely couple the midfoot segment 623 and the heel segment 624 together.

In the medial/lateral direction, a portion of the midfoot segment 623 is positioned outwards of the heel segment 624. For example, a portion of the heel segment 624 is positioned closer to the foot-receiving cavity 606 than a portion of the midfoot segment 623. In some examples, a portion of the midfoot segment 623 can be positioned closer to the foot-receiving cavity 606 than a portion of the heel segment 624.

Additionally, the posterior edge 650 of the midfoot segment 623 and the anterior edge 652 of the heel segment 624 are spaced apart from each other in the longitudinal direction. For example, the anterior edge 652 of the heel segment 624 is positioned closer to the forefoot portion 610 of the article of footwear 600 than the posterior edge 650 of the midfoot segment 623.

In some examples, other segments of the body 620 can overlap in the lateral and longitudinal directions. For example, the forefoot segment 622 and the midfoot segment 623 can overlap in addition to or in alternative to the midfoot segment 623 and the heel segment 624 overlapping.

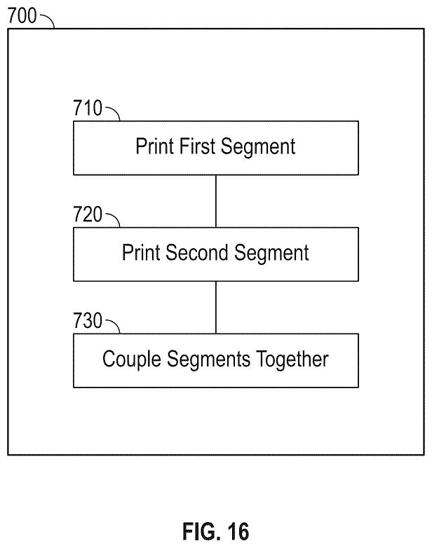

FIG. 16 shows a flowchart 700 illustrating an example process for forming a segmented body of an article of footwear, such as by printing. In this example, in step 710, a first segment of the body is printed by a printer. The printer can print any segmented body, such as any of those described herein (e.g., body 120, body 220, body 320, body 420, body 520, body 620, etc.). As one example, at step 710, the forefoot segment 122 of the body 120 can be printed by the printer.

In step 720, a second segment of the body is printed by a printer. As one example, at step 720, the heel segment 124 of the body 120 can be printed by the printer. Steps 710 and 720 can be performed by the same printer or different printers. In some examples, steps 710 and 720 can be performed simultaneously, such that both segments (e.g., segments 122 and 124) are printed at the same time. The segments can be printed using any of printable materials described above. Steps 710 and/or step 720 can be repeated depending on the number of segments included in the body.

In some examples, the segments can be printed in steps 710 and 720 with mating faces of each segment positioned downwardly (e.g., positioned on the printing surface). For example, the heel segment 124 is shown in this orientation in FIG. 3 with the anterior face 130 facing downwardly. As one example, when the segments 122 and 124 are printed in steps 710 and 720, the posterior face 128 of the forefoot segment 122 and the anterior face 130 of the heel segment 124 can be the first layer that is printed on the printing surface. As described above, this orientation enables successive layers to be printed on existing layers (e.g., without overhanging portions), such that external or extrinsic supports are not needed. For example, the foot-receiving cavity of the body can be unsupported during printing in steps 710 and 720.

In step 730, the segments can be coupled together, for example, with one or more connection members (e.g., any of the connection members described herein). For example, each segment can include an opening that receives the connection member and when the segments are coupled together, the mating faces of the segments are mated together. In some examples, the segments can be coupled together in step 730 without the use of adhesive.

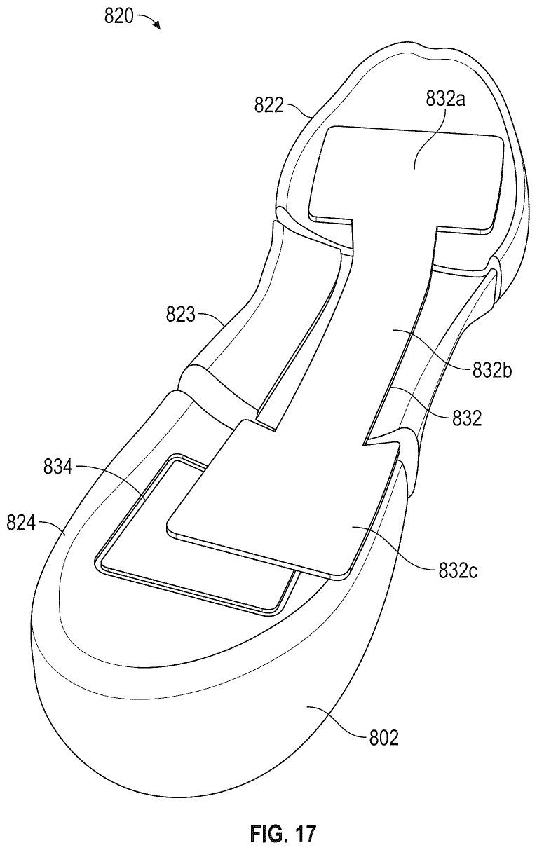

FIG. 17 shows a body 820 for an article of footwear with a non-uniformly shaped connection member 832 that is partially disposed within an opening 834 in the body 820. Similar to other bodies for articles of footwear described herein, the body 820 is divided into a forefoot segment 822, a midfoot segment 823, and a heel segment 824 and includes an opening 834 to receive the connection member 832. The body 820 comprises a sole structure 802, similar to other sole structures described herein. In some examples, an upper (e.g., upper 304, upper 404) can be formed separately from the body 820 and coupled thereto, as described above in connection with article of footwear 300 and article of footwear 400. In some examples, the body 820 can include an upper (e.g., similar to body 120, body 220, etc.), such that each segment of the body 820 is integrally formed as a unitary structure with a portion of the sole structure 802 and a portion of the upper.

In some examples, the connection member 832 can be configured as a plate that has a non-uniform shape along its length. For example, the connection member 832 can have one or more areas along its length that are relatively wider than other areas of the connection member 832. In some examples, the wider portion(s) of the connection member 832 can help couple the segments 822, 823, 824 of the body 820 together and help retain the connection member 832 within the opening 834. As shown in FIG. 17, end portions 832a, 832b of the connection member 832 are wider than a central portion 832c of the connection member 832. In some examples, the end portions 832a, 832b can have a polygonal shape and/or a rounded shape. In some examples, the end portion 832a and the end portion 832b have different shapes (e.g., rectangular, square, etc.) and/or different sizes. The connection member 832 can also be considered as having a dog bone shape. In the illustrated example, the end portion 832a is disposed in the forefoot segment 822 and the end portion 832b is disposed in the heel segment 824 when the connection member 832 is positioned within the opening 834.

As shown in FIG. 17, the opening 834 is sized and shaped to receive the connection member 832, for example, with a friction fit. The opening 834 is configured as a recess in an upper surface of the sole structure 802 and the connection member 832 rests on the sole structure 802 within the opening 834. As such, when the connection member 832 is disposed within the opening 834, the connection member 832 partially defines the foot-receiving cavity. Thus, when a user wears an article of footwear including the body 820, the user's foot can be configured to contact the connection member 832. In some examples, the weight of the user wearing the article of footwear against the connection member 832 can help lock the segments 822, 823, 824 of the body 820 together.

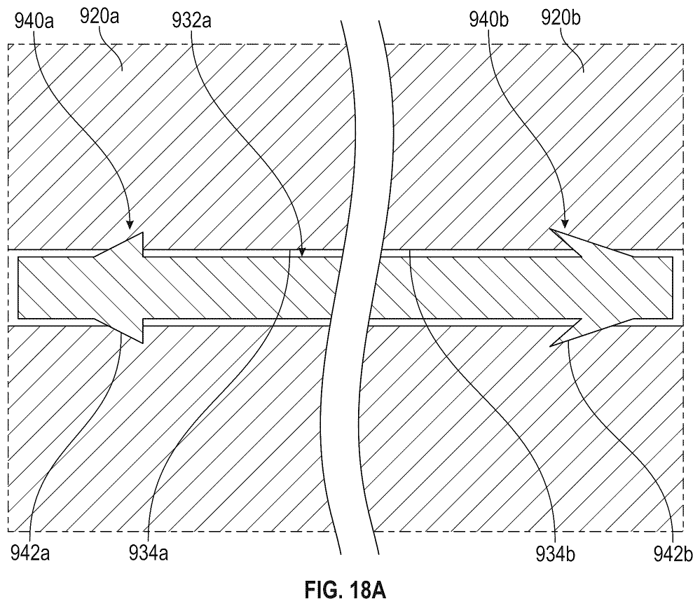

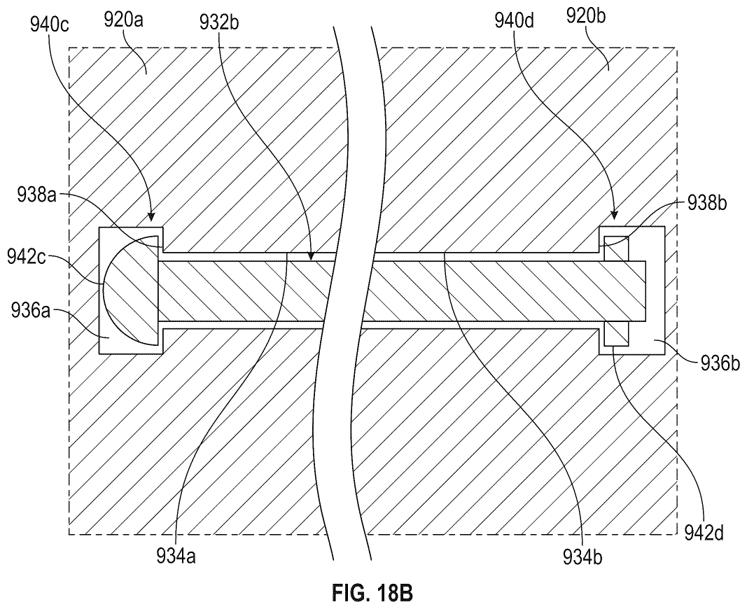

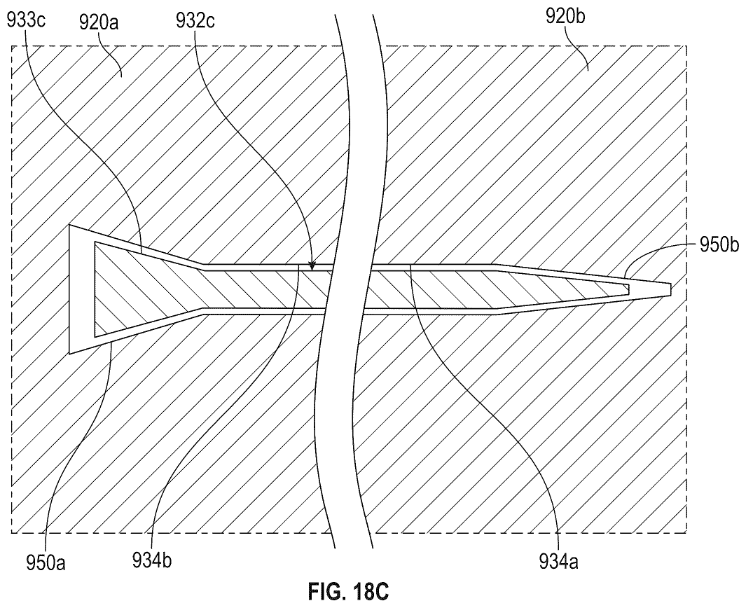

FIGS. 18A-18C illustrate various manners in which the connection members disclosed herein may be received in the corresponding openings disclosed herein to restrict and/or prevent removal of the connection members from the openings. Each of FIGS. 18A-18C depicts a corresponding connection member 932a-932c extending within each of a first opening 934a formed in a first body segment 920a and a second opening 934b formed in a second body segment 920b. The first body segment 920a and the second body segment 920b each may represent any corresponding segments of the bodies of the footwear disclosed herein, such as the forefoot segments 122, 222, 322, 433, and/or 822, the midfoot segments 223, 423, 523, 623, and/or 823, and/or the heel segments 124, 224, 324, 424, 524, 624, and/or 824 of the bodies 120, 220, 320, 420, 520, 620, and/or 820. The first opening 934a and the second opening 934b each may represent any corresponding openings disclosed herein, such as the openings 134, 234, and/or 834. Each of the connection members 932a-932c may represent any of the connection members disclosed herein, such as the connection members 132, 232, and/or 834.

In the example of FIG. 18A, the connection member 932a includes a first engagement structure 940a that engages the first opening 934a (and/or a portion of the first body segment 920a that defines the second opening 934a) and a second engagement structure 940b that engages the second opening 934b (and/or a portion of the second body segment 920b that defines the second opening 934b). In this example, the first engagement structure 940a includes one or more teeth 942a that engage the first body segment 920a and the second engagement structure 940b includes one or more barbs 942b that engage the second body segment 920b. As shown in FIG. 18A, the teeth 942a and the barbs 942b can be configured (e.g., oriented) in a manner that allows the first engagement structure 940a to be inserted into the openings 934a/934b but restricts the first engagement structure 940a from being removed from the openings 934a/934b.

In the example of FIG. 18B, the connection member 932b includes a third engagement structure 940c that engages the first opening 934a (and/or a portion of the first body segment 920a that defines the second opening 934a) and a fourth engagement structure 940d that engages the second opening 934b (and/or a portion of the second body segment 920b that defines the second opening 934b). In this example, the third engagement structure 940c includes an enlarged head portion 942c that extends into an engagement structure receiver 936a of the first opening 934a. In this manner, the connection member 932b is restricted from being removed from the first opening 934a via engagement between the head portion 942c and a wall 938a of the first opening 934a.

In the example of FIG. 18B, the fourth engagement structure 940d includes one or more tabs 942d that extends into an engagement structure receiver 936b of the second opening 934b. In this manner, the connection member 932b is restricted from being removed from the second opening 934b via engagement between the tabs 942d and a wall 938b of the second opening 934b.

In the example of FIG. 18C, the connection member 932c includes an end region 933c that is flared radially outward to frictionally engage the first opening 934a (and/or a portion of the first body segment 920a that defines the first opening 934a). In this manner, the end region 933c of the connection member 932c is wider than a central portion of the connection member 932c. In some examples, and as shown in FIG. 18C, an end region 950a of the first opening 934a also may be flared radially outward, such as to restrict removal of the connection member 932c from the first opening 934a.

In the example of FIG. 18C, the second opening 934b is tapered toward an end region 950b thereof such that the second body segment 920b frictionally engages the connection member 932c. In some examples, and as shown in FIG. 18C, the connection member 932c may be formed of a compressible and/or resilient material such that the connection member 932c deforms slightly to take the shape of the tapered end region 950b. In other examples, the connection member 932c may be substantially rigid such that the tapered end region 950b frictionally engages and exerts a compressive force on the connection member 932c without deforming the connection member 932c. In some examples, the tapered end region 950b of the second opening 934b may be described as representing an example and/or a portion of an engagement structure.

Further aspects of the disclosure are provided by the subject matter of the following examples:

Example 1. An article of footwear, comprising: a three-dimensionally printed body having a longitudinal axis extending from a forefoot region of the body to a heel region of the body, wherein the body comprises a plurality of discrete segments that are coupled together, wherein a first segment of the plurality of segments defines the forefoot region and a second segment of the plurality of segments defines the heel region, wherein each segment of the plurality of segments includes an opening extending in a direction parallel to the longitudinal axis; and a connection member extending through the openings of the segments from the first segment to the second segment, wherein the connection member couples the plurality of segments together.

Example 2. The article of footwear of example 1, wherein the plurality of segments comprises a third segment that defines a midfoot region of the body.

Example 3. The article of footwear of example 1 or example 2, wherein each of the plurality of segments includes multiple openings extending in a direction parallel to the longitudinal axis.

Example 4. The article of footwear of example 3, wherein multiple connection members extend through the multiple openings of the plurality of segments.

Example 5. The article of footwear of any one of examples 1-4, wherein the connection member comprises an outer rod and an inner rod that extends through a central opening of the outer rod, and optionally wherein the inner rod is concentric with the outer rod.

Example 6. The article of footwear of any one of examples 1-5, wherein the openings of the segments are configured as recesses, and wherein an end portion of the connection member is wider than a central portion of the connection member.

Example 7. The article of footwear of any one of examples 1-6, wherein the plurality of segments is coupled together without adhesive.

Example 8. The article of footwear of any one of examples 1-7, wherein the body comprises a sole structure.

Example 9. The article of footwear of any one of examples 1-8, wherein the body comprises an upper.

Example 10. The article of footwear of any one of examples 1-9, wherein the body comprises a sole structure and an upper coupled to the sole structure.

Example 11. The article of footwear of any one of examples 1-10, wherein the body defines a foot-receiving cavity, and wherein the second segment defines a foot opening that provides access to the foot-receiving cavity.

Example 12. The article of footwear of any one of examples 1-11, further comprising an outsole coupled to the plurality of segments.

Example 13. The article of footwear of example 12, further comprising one or more seams, wherein each pair of adjacent segments of the plurality of segments meet at a corresponding seam of the one or more seams, and wherein the outsole extends across at least one seam of the one or more seams to couple the plurality of segments to one another.

Example 14. The article of footwear of any one of examples 12-13, wherein the outsole comprises a first outsole portion and a second outsole portion that is spaced apart from the first outsole portion.

Example 15. The article of footwear of example 14, wherein one or both of the first outsole portion and the second outsole portion extends over a seam at which adjacent segments of the plurality of segments meet on a medial side portion or a lateral side portion of the article of footwear.

Example 16. An article of footwear, comprising: a body comprising an upper configured to receive a wearer's foot and a sole structure configured to be disposed under the wearer's foot, wherein the body comprises a plurality of discrete segments including a forefoot segment and a heel segment, wherein the forefoot segment includes a forefoot portion of the upper and a forefoot portion of the sole structure, wherein the forefoot portions of the upper and the sole structure are integrally formed as a unitary structure, wherein the heel segment includes a heel portion of the upper and a heel portion of the sole structure, wherein the heel portions of the upper and the sole structure are integrally formed as a unitary structure; and at least one connection member extending between the forefoot segment and the heel segment, wherein the connection member is disposed in at least one opening of the plurality of segments.

Example 17. The article of footwear of example 16, wherein the sole structure comprises a midsole portion and an outsole portion.

Example 18. The article of footwear of example 16 or example 17, wherein the at least one connection member comprises a rectangular structure and/or a cylindrical structure.

Example 19. The article of footwear of any one of examples 16-18, wherein the plurality of segments comprises a printable material, wherein the printable material is one or more of TPU, thermoplastic polyolefins, and thermoplastic PEBAs.

Example 20. The article of footwear of any one of examples 16-19, wherein the plurality of discrete segments includes a midfoot segment disposed between the forefoot segment and the heel segment in a longitudinal direction, wherein the midfoot segment includes a midfoot portion of the upper and a midfoot portion of the sole structure, and wherein the midfoot portions of the upper and the sole structure are integrally formed as a unitary structure.

Example 21. The article of footwear of any one of examples 16-20, wherein the body defines a foot-receiving cavity between the upper and the sole structure, and wherein the heel segment at least partially defines a foot opening that provides access to the foot-receiving cavity.

Example 22. The article of footwear of example 21, further comprising one or more cushioning elements disposed in the sole structure and configured to be positioned inferior to a wearer's foot that is disposed in the foot-receiving cavity.

Example 23. An article of footwear, comprising: a body at least partially defining a foot-receiving cavity, wherein the body comprises a plurality of individual segments that are coupled together, wherein a first segment of the plurality of segments includes a posterior face extending in a superior/inferior direction and in a medial/lateral direction, wherein a second segment of the plurality of segments includes an anterior face extending in the superior/inferior direction and in the medial/lateral direction, wherein the first segment is positioned anterior to the second segment in an anterior/posterior direction, wherein each of the plurality of segments includes at least one opening positioned inferior to the foot-receiving cavity in the superior/inferior direction; and a connection member disposed within the openings of the segments from the first segment to the second segment in the anterior/posterior direction, wherein the connection member couples the plurality of segments together.

Example 24. The article of footwear of example 23, wherein the posterior face of the first segment abuts the anterior face of the second segment when the plurality of segments is coupled together with the connection member.

Example 25. The article of footwear of example 23 or example 24, wherein the posterior face of the first segment overlaps with the anterior face of the second segment in the anterior/posterior direction when the plurality of segments is coupled together with the connection member.

Example 26. The article of footwear of any one of examples 23-25, wherein the body comprises an upper configured to receive a wearer's foot and a sole structure configured to be disposed under the wearer's foot.

Example 27. The article of footwear of any one of examples 23-26, wherein the body comprises a printable material, wherein the printable material comprises a thermoplastic material.

Example 28. A method of forming an article of footwear, the method comprising: printing a forefoot segment comprising a forefoot portion of an upper, a forefoot portion of a sole structure, and a first opening configured to receive a connection member; and printing a heel segment comprising a heel portion of the upper, a heel portion of the sole structure, and a second opening configured to receive the connection member.

Example 29. The method of example 28, further comprising coupling the forefoot segment to the heel segment with the connection member.

Example 30. The method of example 29, wherein coupling the forefoot segment to the heel segment comprises inserting the connection member into the opening of the forefoot segment and the opening of the heel segment without the use of adhesive.

Example 31. The method of any one of examples 28-30, wherein printing the forefoot segment and printing the heel segment occurs simultaneously.

Example 32. The method of any one of examples 28-31, wherein printing the forefoot segment comprises printing the forefoot segment with a mating surface of the forefoot segment facing downwardly during printing; and wherein printing the heel segment comprises printing the heel segment with a mating surface of the heel segment facing downwardly during printing.

Example 33. The method of any one of examples 28-32, wherein during the act of printing a foot-receiving cavity between the upper and the sole structure is unsupported.

Example 34. The method of any one of examples 28-33, further comprising printing a midfoot segment comprising a midfoot portion of the upper, a midfoot portion of the sole structure, and a third opening configured to receive the connection member.

Example 35. A method of forming an article of footwear, the method comprising: printing a first segment of a body of an article of footwear, the first segment comprising a first mating surface; and printing a second segment of the body of the article of footwear, the second segment comprising a second mating surface configured to mate with the first mating surface, wherein the first and second mating surfaces are oriented downwardly during printing.

Example 36. The method of example 35, wherein printing a first segment comprises printing a first segment comprising at least a portion of a foot-receiving cavity, wherein the foot-receiving cavity is unsupported during printing.

Example 37. The method of example 35 or example 36, further comprising coupling the first segment and the second segment together with a connection member such that the first mating surface is mated with the second mating surface.

Example 38. The method of any one of examples 35-37, wherein printing the first segment and printing the second segment occurs simultaneously.

Any feature(s) of any example(s) disclosed herein can be combined with or isolated from any feature(s) of any example(s) disclosed herein, unless otherwise stated. For example, an article of footwear may comprise a connection member disclosed herein (e.g., the connection member 232—see FIGS. 6-10) in combination with another type of segmented body.

In view of the many possible examples to which the principles of the disclosure may be applied, it should be recognized that the illustrated examples should not be taken as limiting the scope of the claims. Rather, the scope of the claimed subject matter is defined by the following claims and their equivalents.

1. An article of footwear, comprising:
a three-dimensionally printed body having a longitudinal axis extending from a forefoot region of the body to a heel region of the body, wherein the body comprises a plurality of discrete segments that are coupled together, wherein a first segment of the plurality of segments defines the forefoot region and a second segment of the plurality of segments defines the heel region, wherein each segment of the plurality of segments includes an opening extending in a direction parallel to the longitudinal axis; and
a connection member disposed within the openings of the segments from the first segment to the second segment, wherein the connection member couples the plurality of segments together.

2. The article of footwear of claim 1, wherein the plurality of segments comprises a third segment that defines a midfoot region of the body.

3. The article of footwear of claim 1, wherein each of the plurality of segments includes multiple openings extending in a direction parallel to the longitudinal axis, and wherein multiple connection members extend through the multiple openings of the plurality of segments.

4. The article of footwear of claim 1, wherein the connection member comprises an outer rod and an inner rod that extends through a central opening of the outer rod.

5. The article of footwear of claim 1, wherein the openings of the segments are configured as recesses, and wherein an end portion of the connection member is wider than a central portion of the connection member.

6. The article of footwear of claim 1, wherein the plurality of segments is coupled together without adhesive.

7. The article of footwear of claim 1, wherein the body comprises a sole structure and an upper coupled to the sole structure.

8. The article of footwear of claim 1, further comprising an outsole coupled to the plurality of segments.

9. The article of footwear of claim 8, further comprising one or more seams, wherein each pair of adjacent segments of the plurality of segments meet at a corresponding seam of the one or more seams, and wherein the outsole extends across at least one seam of the one or more seams to couple the plurality of segments to one another.

10. The article of footwear of claim 8, wherein the outsole comprises a first outsole portion and a second outsole portion that is spaced apart from the first outsole portion.

11. The article of footwear of claim 10, wherein one or both of the first outsole portion and the second outsole portion extends over a seam at which adjacent segments of the plurality of segments meet on a medial side portion or a lateral side portion of the article of footwear.

12. An article of footwear, comprising:
a body at least partially defining a foot-receiving cavity, wherein the body comprises a plurality of individual segments that are coupled together, wherein a first segment of the plurality of segments includes a posterior face extending in a superior/inferior direction and in a medial/lateral direction, wherein a second segment of the plurality of segments includes an anterior face extending in the superior/inferior direction and in the medial/lateral direction, wherein the first segment is positioned anterior to the second segment in an anterior/posterior direction, wherein each of the plurality of segments includes at least one opening positioned inferior to the foot-receiving cavity in the superior/inferior direction; and
a connection member disposed within the openings of the segments from the first segment to the second segment in the anterior/posterior direction, wherein the connection member couples the plurality of segments together.

13. The article of footwear of claim 12, wherein the posterior face of the first segment abuts the anterior face of the second segment when the plurality of segments is coupled together with the connection member.

14. The article of footwear of claim 12, wherein the posterior face of the first segment overlaps with the anterior face of the second segment in the anterior/posterior direction when the plurality of segments is coupled together with the connection member.

15. The article of footwear of claim 12, wherein the body comprises a printable material, wherein the printable material comprises a thermoplastic material.

16. A method of forming an article of footwear, the method comprising:
printing a forefoot segment comprising a forefoot portion of an upper, a forefoot portion of a sole structure, and a first opening configured to receive a connection member;
printing a heel segment comprising a heel portion of the upper, a heel portion of the sole structure, and a second opening configured to receive the connection member; and
coupling the forefoot segment to the heel segment with the connection member.

17. The method of claim 16, wherein printing the forefoot segment and printing the heel segment occurs simultaneously.

18. The method of claim 16, wherein printing the forefoot segment comprises printing the forefoot segment with a mating surface of the forefoot segment facing downwardly during printing; and wherein printing the heel segment comprises printing the heel segment with a mating surface of the heel segment facing downwardly during printing.

19. The method of claim 16, wherein during the act of printing a foot-receiving cavity between the upper and the sole structure is unsupported.

20. The method of claim 16, further comprising printing a midfoot segment comprising a midfoot portion of the upper, a midfoot portion of the sole structure, and a third opening configured to receive the connection member.
